(19) United States
(12) Patent Application Publication
(10) Pub. No.: US 2005/0057359 A1
(43) Pub. Date: Mar. 17, 2005

(54) Transmitter unit and control unit

(76) Inventors: Conor Coffey, San Diego, CA (US); Sean Coffey, Sydney (AU); Joe Dowling, Aughnacliffe (IE)

Correspondence Address: FISH & RICHARDSON, PC, 12390 EL CAMINO REAL, SAN DIEGO, CA, 92130-2081, US

(21) Appl. No.: 10/918,211

(22) Filed: Aug. 12, 2004

Related U.S. Application Data
(60) Provisional application No. 60/494,658, filed on Aug. 12, 2003.

(51) Int. Cl. G08B 1/08

(52) U.S. Cl. 340/539.21; 340/573.4

(57) ABSTRACT

Methods and apparatus that implement a transmitter unit and a control unit to alert a user if the control unit is beyond a limited range of communications. A method of alerting a user that a transmitter unit is beyond a limited range of communicating wirelessly with a control unit may include, wirelessly transmitting a radio frequency signal from the transmitter unit to the control unit, determining at the control unit whether the transmitter unit is beyond the limited range of wireless communications, and selectively generating an alert at the control unit based on a result of the determination. Determining at the control unit whether the transmitter unit is beyond the limited range of wireless communications may include detecting an occurrence of a predetermined condition.

### CROSS-REFERENCE TO RELATED APPLICATIONS

This application claims the benefit of priority from U.S. Provisional Application Ser. No. 60/494,658, entitled “BRACELET UNIT AND CONTROL UNIT”, filed Aug. 12, 2003, the disclosure of which is incorporated by reference.

### BACKGROUND

The following description relates to a transmitter unit and a control unit to alert a user if the control unit is beyond a limited range of communications.

Typically, parents may use public resources to find a missing or abducted child. One public resource is the AMBER (America's Missing: Broadcast Emergency Response) Plan, which is a network established in order to facilitate the recovery of abducted children. Among other activities, the AMBER Plan uses highway signs, airwaves, the Internet, and word-of-mouth through participating members to publicize abductions. The AMBER Plan may instantly galvanize an entire community to assist in the search for, and safe return of, the child by encouraging the public to look for the missing child and/or suspect. The network may be effective once a proper official is notified and the AMBER Plan is used.

Parents may also resort to self-help measures, such as using personal locating devices. One such device, produced by Wherify Wireless, is referred to as a Global Positioning System (hereinafter “GPS”) personal locator (available from Wherify Wireless, Redwood Shores, Calif.) and uses GPS to determine the location of a child once it is determined that the child may be lost or abducted.

### SUMMARY

Described herein are methods and apparatus that implement a transmitter unit and a control unit to alert a user if the control unit is beyond a limited range of communications.

In one general aspect, a system includes a transmitter unit operable to transmit radio frequency signals within a limited range of communications, and a control unit operable to receive radio frequency signals from the transmitter unit and to generate an alert if the control unit determines that the transmitter unit is beyond the limited range of communications.

Implementations may include one or more of the following features. The control unit may be configured to determine that the transmitter unit is beyond the limited range of communications upon detecting an occurrence of a predetermined condition. Detecting an occurrence of the predetermined condition may include detecting that the transmitter unit failed to transmit a radio frequency signal within a predetermined period of time. The control unit may be adapted to transmit radio frequency signals to the transmitter unit at regular intervals, and the transmitter unit may be adapted to send response signals to the control unit. In that case, detecting an occurrence of the predetermined condition may include detecting that the transmitter unit failed to respond to a transmission from the control unit.

The control unit may be adapted to measure a strength of a signal from the transmitter unit. In that case, detecting an occurrence of the predetermined condition may include detecting that the control unit received a signal from the transmitter unit below a predetermined signal strength level. The control unit may be adapted to store predetermined signal strength levels, and configured to allow a user to select one of the predetermined signal strength levels such that the control unit generates the alert based on the signal strength selected by the user.

The control unit may be configured to determine that the transmitter unit is beyond the limited range of communications when at least the radio frequency signals from the transmitter unit are obstructed, the radio frequency signals fail to be received at the control unit when the transmitter unit has low power or is not powered, or the control unit or the transmitter unit malfunctions.

The transmitter unit may be adapted to be secured to a person. The transmitter unit may include a bracelet. The control unit may be adapted to transmit radio frequency signals to the transmitter unit at regular intervals, and the transmitter unit may be adapted to send response signals to the control unit. The control unit may increase a frequency of transmitting signals if the transmitter unit is out of the limited range of communications with the control unit.

The control unit may communicate with the transmitter unit using a Bluetooth radio frequency link. The alert may be an audible alarm, a visual alarm, or a vibration alarm. The transmitter unit may be adapted to generate an alert if the transmitter unit determines that the control unit is beyond the limited range of communications. The control unit may be mobile.

The control unit may be a bracelet adapted to be secured around part of a person. The control unit may be adapted to send alert signals to a device via the Internet such that generating the alert includes sending alert signals to the device via the Internet. The control unit may be adapted to send wireless alert signals to a device such that generating the alert includes wirelessly sending alert signals to the device.

The control unit may recognize a unique communication address of the transmitter unit. The control unit may be adapted to communicate with transmitter units using continuous streams of radio frequency signals with limited ranges of wireless communications. In that case, the control unit can identify the transmitter unit among transmitter units that are beyond one of the limited ranges of wireless communications, and the control unit can generate the alert if at least one of the transmitter units is beyond one of the limited ranges of wireless communications.

In another aspect, a method of alerting a user that a transmitter unit is beyond a limited range of communicating wirelessly with a control unit may include, wirelessly transmitting a radio frequency signal from the transmitter unit to the control unit, determining at the control unit whether the transmitter unit is beyond the limited range of wireless communications, and selectively generating an alert at the control unit based on a result of the determination.

Implementations may include one or more of the following features. Determining at the control unit whether the transmitter unit is beyond the limited range of wireless communications may include detecting an occurrence of a predetermined condition. Detecting an occurrence of the predetermined condition may include detecting that the transmitter unit failed to transmit the radio frequency signal within a predetermined period of time; detecting that the transmitter unit failed to respond to a transmission from the control unit; and/or detecting that the radio frequency signal from the transmitter unit is below a predetermined signal strength level.

The transmitter unit may be beyond the limited range of wireless communications when at least the radio frequency signal from the transmitter unit is obstructed, the radio frequency signal fails to be received at the control unit when the transmitter unit has low power or is not powered, or the control unit or the transmitter unit malfunctions. The transmitter unit may be a bracelet and/or the control unit may be a bracelet.

Determining whether the transmitter unit is beyond the limited range of wireless communications may include measuring a strength of the signal transmitted by the transmitter unit, and determining that the control unit is beyond the limited range of wireless communications if the measured strength is below a predetermined level. Determining whether the transmitter unit is beyond the limited range of wireless communications may include determining whether a strength of the radio frequency signal is below the selected predetermined level. In that case, the method further includes receiving input selecting a predetermined signal strength level at the control unit.

The method may further include the control unit selectively transmitting alert signals to a device if the transmitter unit is beyond the limited range of wireless communications. The control unit may be adapted to communicate with transmitter units using continuous streams of radio frequency signals with limited ranges of wireless communications. In that case, the control unit may be configured to generate the alert if at least one transmitter units is beyond one of the limited ranges of wireless communications, where determining that the control unit is beyond the limited range of wireless communications includes the control unit identifying the transmitter unit among transmitter units that are beyond the limited range of communications.

In another aspect, a control unit includes a receiver to receive radio frequency signals from one or more transmitter units, circuitry to determine whether one or more of the transmitter units are within a limited wireless communications range, and circuitry to selectively alert a user of the control unit upon determining that one or more of the transmitter units are outside of the limited wireless communication range.

Implementations may include one or more of the following features. The control unit may be a bracelet. The circuitry to determine whether one or more of the transmitter units are within a limited wireless communications range may be configured to determine that the transmitter units are within the limited wireless communications range upon detecting an occurrence of a predetermined condition. Detecting an occurrence of the predetermined condition may include detecting that the transmitter unit failed to transmit a radio frequency signal within a predetermined period of time. The control unit may further include circuitry to measure the strength of the received radio frequency signals. In that case, detecting an occurrence of the predetermined condition may include detecting that a measured strength of radio frequency signals is below a predetermined signal strength level.

The control unit may be beyond the limited range of wireless communications if the measured strength is below a selected predetermined level. The control unit may further include circuitry to store predetermined signal strength levels and circuitry to allow a user to select one of the predetermined signal strength levels.

The circuitry to determine whether one or more of the transmitter units are within a limited wireless communications range may be configured to determine that the transmitter units are within a limited wireless communications range when at least the radio frequency signals from the transmitter units are obstructed, the radio frequency signals fail to be received at the control unit when the transmitter units have low power or are not powered, or the control unit or the transmitter units malfunction. The circuitry to determine whether one or more of the transmitter units are within a limited wireless communications range may be configured to determine that the transmitter units are within a limited wireless communications range if the control unit fails to receive a response to a radio frequency signal sent from the control unit. In that case, the control unit further includes circuitry configured to send a continuous stream of radio frequency signals with the limited range of communications to the transmitter unit.

The transmitter unit and control unit described herein may provide one or more of the following advantages. The transmitter unit and the control unit communicate with each other such that the control unit can determine when the transmitter unit has or has not gone beyond a limited range of communications, or is otherwise unable to communicate with the transmitter unit (e.g., turned off, dead battery, obstructed signal, tampered with, removed, etc.). Thus, for example, the transmitter unit may be attached to a child, such as by housing the transmitter unit in a bracelet, and the control unit may be used by a parent, such that a parent may determine, as a result of receiving continuous periodic signals from the transmitter bracelet, that the child has not wandered off, has not gone missing, and/or are has not been abducted. In some implementations, the signal strength may be used to determine that the transmitter unit has gone beyond a range of communications. Different signal strength thresholds may be stored in the control unit for selection by a user such that a user can choose a preferred distance. The transmitter unit and the control unit may be mobile, thus a system including the units may be mobile. Because the transmitter unit and the control unit may be implemented using off-the-shelf components, and few components at that, a system including the units may be manufactured in an economic and efficient manner. In addition to ensuring that children do not stray past a safe distance, the techniques and/or system may be adapted to ensure that valuables are not moved past a safe distance. Because the control unit can automatically determine that the control unit is unable to communicate with the transmitter unit, the automatic monitoring does not require lost items to be searched for first, so a user need not wait to determine that something is missing, they may know immediately as a result of not receiving the periodic signals.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

FIGS. 1A and 1B illustrate communication between a control unit and a transmitter unit.

FIG. 2 is a flowchart of a process for alerting a user that a transmitter unit is beyond a limited range of communications with a control unit.

FIGS. 3A and 3B are schematic diagrams of a control unit and a transmitter unit.

FIGS. 4A and 4B are flowcharts illustrating processes performed by a control unit and a transmitter unit.

Like reference numbers and designations in the various drawings indicate like elements.

### DETAILED DESCRIPTION

This application claims priority under 35 USC §119(e) to U.S. Provisional Application Ser. No. 60/494,658, filed on Aug. 12, 2003, the entire contents of which are hereby incorporated by reference.

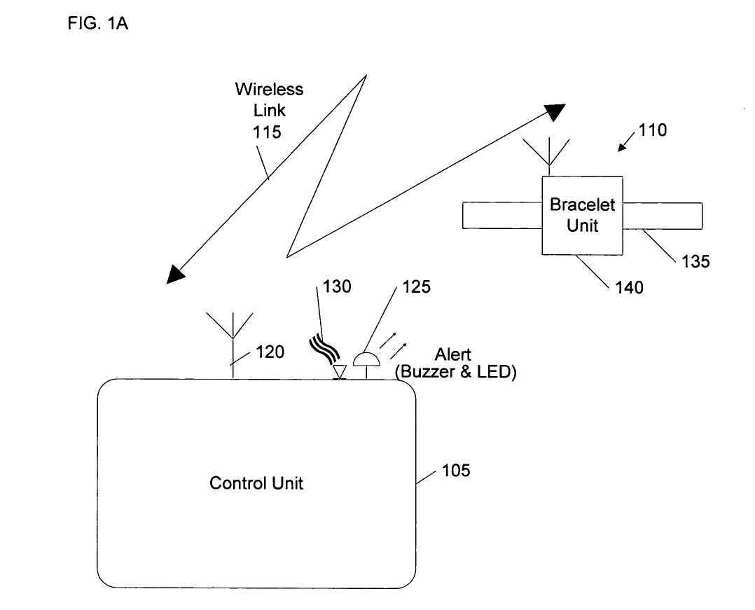

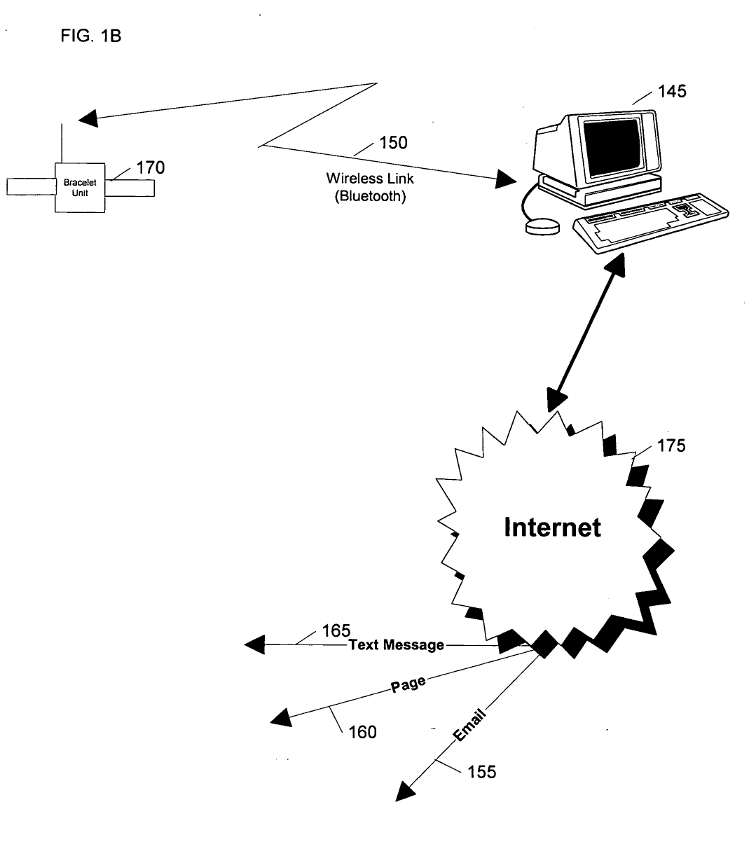

FIGS. 1A and 1B illustrate communication between a control unit and a transmitter unit. In FIG. 1A, a control unit 105 and a bracelet unit 110 (i.e., an implementation of a transmitter unit) can communicate via a communication link 115. If the control unit 105 determines that the bracelet unit 110 is beyond a range of the control unit 105 such that the control unit cannot communicate via the communication link 115, the control unit 105 can generate an alert, such as an audible alert or a visual alert. To determine that the bracelet unit 110 is beyond the range of the control unit 105, the control unit 105 attempts to communicate with the bracelet unit 105. The control unit 105 can send a signal to the bracelet unit 110 and wait for a response from the bracelet unit 110. If the control unit 105 does not receive a response to the signal sent by the control unit 105 within a predetermined amount of time, the control unit 105 can determine that the bracelet unit 110 is outside of the range of communications. An indication that the bracelet unit 110 is outside of the communication range may arise under any of various circumstances. As examples, a physical separation distance between the bracelet unit 110 and the control unit 105 may be too great; an obstruction that hinders radio frequency waves may be between the bracelet unit 110 and the control unit 105; and/or the bracelet unit 110 or the control unit 105 are turned off, low on power, removed, tampered with, or not functioning.

If the bracelet unit 110 does respond by sending a signal and the signal is received by the control unit 105, the control unit 105 can determine that the bracelet unit 110 is within the communication range. In either case, the control unit 105 may continue operating by sending a signal to the bracelet unit 110 from time to time to see if the bracelet unit 110 moves outside of the communication range or if the bracelet unit 110 moves back inside the communication range. Thus, the control unit 105 can periodically send signals to the bracelet unit 110 to determine the whether the bracelet unit 110 is within the communication range.

The control unit 105 includes hardware for communicating with the bracelet unit 110, such as the antenna 120; control circuitry for determining if the bracelet unit is beyond a limited range of communication; and alert devices 125 and 130. The control unit 105 can communicate with the bracelet unit 110 using hardware designed in accordance with the Bluetooth specification (Bluetooth specification available from Bluetooth SIG, Inc., Overland Park, Kans.). The control unit 105 and the bracelet unit 110 may conform to different classes of the Bluetooth specification, or the same classes of the specification. As an example, the control unit 105 may conform to the second class of Bluetooth, which has a limited range of communications, and the bracelet unit 110 may conform to the first class of Bluetooth, which has a more limited range of communications. Because of the limited range of communications for Bluetooth devices, the ability of the devices to communicate can be a proxy for determining if a user of the bracelet unit 110 is beyond a safe distance from the user of the control unit 105 because, as described earlier, when the control unit 105 and the bracelet unit 110 cannot communicate, the control unit 105 can generate an alert. In addition to, or instead of, being limited by transmission distance alone, the limited range of communications may also be limited obstacles (i.e., obstructions). In alternative implementations, types of radio frequency technology other than Bluetooth may be used to transmit signals.

Because the control unit 105 and the bracelet unit 110 communicate via the communication link 115, which is relative to the location of the control unit 105 and the bracelet unit 110, the units are not tied to fixed networks or locations. Thus, if both units are mobile, the entire system, including the units 105 and 110, may be mobile. Also, because the system need not depend on fixed networks for communication between the units (e.g., need not depend on a cellular network) the units may operate regardless of the condition of fixed networks (e.g., cellular reception).

The alert devices 125 and 130 can alert a user that the bracelet unit 110 is out of a communication range with the control unit 105. The alert device 125 is a visual alert. A visual alert may be, for example, a light emitting diode, or any other suitable device that can visually alert a user. The alert device 130 is an audible alert. An audible alert device may include, for example, a speaker that beeps, or any other suitable device that can audibly alert a user of the control unit 105. In alternative implementations the control unit 105 may include any number or type of alerts. For example, the control unit 105 may include a vibrating alert such that a user may be alerted discretely that the bracelet unit 110 is beyond the range of communications of the control unit 105.

The control unit 105 is adapted to be mobile. The control unit 105 is both lightweight and small, and includes a power supply. In alternative implementations, the control unit 105 may be adapted differently such that the control unit 105 is mobile and may have other features. For example, the control unit 105 may be adapted to be carried on a user by including a clip or other device for attaching to clothing of a user. As another example, the control unit 105 may be adapted to be secured to a person by constructing the control unit 105 as part of a bracelet, similar or identical to the bracelet unit 110. In alternative implementations the control unit 105 need not be mobile, as illustrated by a device similar to the control unit 105, the computer system 145 in FIG. 1B.

The bracelet unit 110 is adapted to be secured on a person. The bracelet unit 110 includes a power supply (e.g., a battery), circuitry for communicating with the control unit 105, and a strap 135. The power supply and circuitry for communicating with the control unit 105 are included in the base unit 140. The base unit 140 is attached to the strap 135, which can be secured around the arm of a person. The bracelet unit 110 may be adapted for outdoor use and durability. For example, the bracelet unit 110 may be waterproof and made of tough materials. In addition, the bracelet unit 110 may be made of a material that is comfortable for being worn over a long period of time. For example, the bracelet unit 110 may be made of a material that does not cause irritation and/or adverse skin reaction when in prolonged contact with skin.

In alternative implementations, the bracelet unit 110 need not be adapted to be secured on a user. For example, the bracelet unit 110 may be adapted to be attached by adhesive, or included, in a Personal Digital Assistant (“PDA”), mobile phone, laptop computer system, etc. with the bracelet unit 110 in a key chain, fob, or in any other device, or the units may be reversed with the bracelet unit 110 attached to (i.e., as a standalone device), or included in, a mobile phone, laptop computer system, etc. and the control unit 105 in a key chain, fob, or in any other device. Thus, in alternative implementations, the control unit 105 and bracelet unit 110 may be used to ensure that valuables, such as PDAs, laptop computer systems, and mobile phones are within a safe range of a user and are not lost. When the valuable goes out of range an alert can notify a user. In alternative implementations, the bracelet unit 110 may be adapted to be secured to a pet. For example, the bracelet unit 110 may be a pendant to be included on a dog collar that may ensure a dog is not beyond a safe distance from a user.

In alternative implementations, the control unit 105 and the bracelet unit 110 need not communicate bi-directionally. For example, the bracelet unit 110 may continuously and/or periodically transmit signals without receiving signals from the control unit 105, and if the control unit 105 does not receive a signal within a predetermined time period (e.g., 1 second, 5 seconds, 10 seconds, etc.) (or determines that the signal strength is too low), the control unit 105 may determine that the bracelet unit 110 is out of a range of communications and the control unit 105 may alert a user.

In alternative implementations, the control unit 105 may implement other techniques, or combinations of techniques, to determine that a control unit 105 is beyond a limited range of communications with the bracelet unit 110. One technique may involve the use of a received signal strength indication (hereinafter “RSSI”). An RSSI may correspond to a distance between the units 105 and 110. The nature of wireless communication is such that the signals are attenuated, or blocked, by the medium through which they pass. If the path between the control unit 105 and the bracelet 110 is “line of sight,” then this medium is referred to as “free space.” Free space attenuates a wireless transmission according to a square law. Therefore, the relationship between the amount of distance between the units, and the level of attenuation is exponential such that a small increase in the distance results in a large increase in attenuation, and therefore a large decrease in an RSSI. Thus, RSSI allows for a measurement of attenuation (as attenuation increases, RSSI decreases), and therefore gives an estimate of a distance between the units 105 and 110 (in a given medium, such as free space).

In accordance with a technique using RSSI, the control unit 105 may measure a strength of one or more signals transmitted from the bracelet unit 110, and if the measured signal strength (i.e., RSSI) is below a predetermined level (i.e., a threshold) the control unit 105 may determine that the bracelet unit 110 is beyond a limited range of communications. Because the RSSI may correlate and/or correspond to a distance between the bracelet unit 110 and the control unit 105, the predetermined level of signal strength used by the control unit 105 may be configured to a strength level that is considered a safe distance between a user of the bracelet unit 110 and the control unit 105. For example, if children are considered to be a safe distance from a parent at 15 feet and the predetermined level is corresponds to a range of communications of 15 feet, a child may wear the bracelet unit 110 and a parent may determine that the child is outside of a safe distance by an alert generated by the control unit 105 at the predetermined level. In alternative implementations, multiple predetermined levels may be provided and the alert generated by the control unit 105 may depend on a selected predetermined level. For example, two predetermined levels may exist, a first level corresponding to a communications range of 15 feet and a second level corresponding to a communication range of 25 feet, and a user can select one of the predetermined levels at the control unit 105. If the user selects the first predetermined level and a signal strength measured by the control unit 105 is below the first level, the control unit 105 may generate an alert. If the user selects the second predetermined level and if the signal strength measured by the control unit 105 is below the second predetermined level, the control unit 105 may generate an alert.

In some implementations, the control unit 105 may increase a frequency of transmitting signals if the bracelet unit 110 is out of the limited range of communications with the control unit 105. This may be advantageous for more accurately determining when the bracelet unit 110 has moved back into the limited range of communications.

In some implementations, the control unit 105 and/or the bracelet unit 110 may be able to differentiate among multiple control units, similar to the control unit 105, and/or multiple bracelet units, similar to the bracelet unit 110. One technique may include the use of a unique address for one or both of the units. For example, each unit may have a unique address transmitted by each unit as part of a signal and the corresponding unit can recognize the unique address of the other type of unit (i.e., the control unit 105 can recognize the unique address of the corresponding bracelet unit 110). The address may be the unique address included in all Bluetooth devices by default. Because the process of sending the address does not include an information exchange between the units, neither unit is interrogated by the other. In other words, the process of sending the address does not involve additional communications.

In some implementations the control unit 105 may support communications with multiple bracelet units, similar to the bracelet unit 110. In those implementations, each bracelet unit 110 may have a unique address that is interpreted by the control unit 105. The control unit 105 may generate an alert if any of the bracelet units are determined to be beyond a range of communications. This may be advantageous, for example, if a parent wants to ensure that multiple children are within a safe distance and the parent does not wish to have multiple control units. As part of generating an alert, the control unit 105 may indicate which bracelet unit is determined to be beyond a range of communications. For example, the control unit 105 may include a liquid crystal display that displays an identifier corresponding to the bracelet unit or units that are determined to be beyond a range of communications.

Alerts need not be generated only at the control unit 105, as in some implementations; alerts may be generated at the bracelet unit 110 as well. For example, the bracelet unit 110 may include a visual alert device and control circuitry for determining if the control unit 105 is beyond a range of communications.

In some implementations, the control unit 105 and the bracelet unit 110 may be substantially similar or identical. For example, each of the units 105 and 110 may include a bracelet that is adapted to be secured on a person and each of the units 105 and 110 may generate an alert if an associated unit is beyond a range of communications. This may be advantageous because manufacturing may be simplified by having one type of unit, which may reduce the cost of each unit. The control unit 105 and the bracelet unit 110 can operate with a master and slave relationship (e.g., the control unit 105 can send signals and generate an alert if a response is not received), or a peer to peer relationship (e.g., if the control unit 105 and the bracelet unit 110 are identical, the bracelet unit 110 can function as an alerting unit with all the capabilities of the control unit 105).

In FIG. 1B, a bracelet unit 170 can communicate with the computer system 145 via a communication link 150. The computer system 145 can generate an alert when the bracelet unit 170 and the computer system 145 are beyond a limited range of communications. The bracelet unit 170 and the computer system 145 may be implemented such that they interact with each other similarly to the bracelet unit 110 and the control unit 105. For example, the computer system 145 includes Bluetooth compatible hardware for communicating with Bluetooth devices.

The computer system 145 can generate alerts and send them via the Internet 175. Generating alerts that can be sent via the Internet 175 may increase the variety of alerts that may be generated, devices that may alert a user, and distances over which an alert may be generated. Alerts that can be generated by the computer system 145 include an electronic mail message 155, a page 160, and a text message 165. The electronic mail message 155 may be sent to a mobile computer system or other device, the page 160 may be sent to a mobile phone or pager, and the text message 165 may be sent to a mobile phone. To send alerts, such as the page 160 and text message 165, the computer system 145 may be capable of connecting to a service or computer system that offers the ability to transmit such messages to the respective devices. To connect to these services and manage a user-preferred alert or alerts, the computer system 145 may include a software program that interfaces with these services. In other implementations, the computer system 145 may generate any type or combination of types of alerts. The computer system 145 may be used in addition to a control unit, such as the control unit 105, thus a system may generate alerts at stationary device, which the computer system 145 may be, and/or by a mobile device, such as the control unit 105.

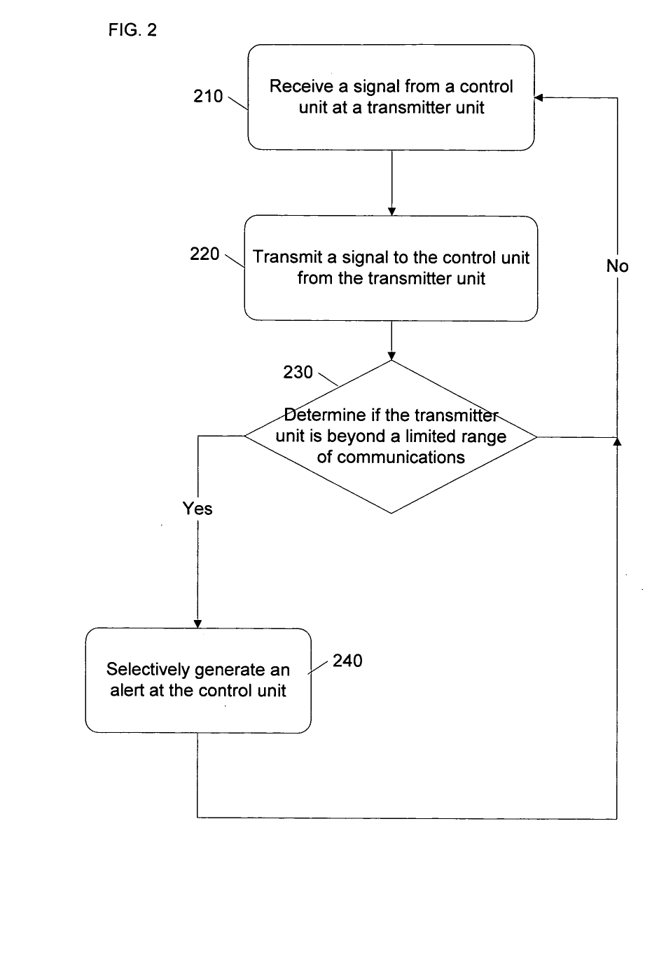

FIG. 2 is a flowchart of a process for alerting a user that a transmitter unit is beyond a limited range of communications with a control unit. The process of FIG. 2 involves radio frequency communication between the transmitter unit and the control unit. The transmitter unit may be similar to the bracelet unit 110 and the control unit may be similar to be control unit 105.

At 210, a signal is received from the control unit at the transmitter unit. The signal is used to indicate the control unit is requesting a response from the transmitter unit. The signal may be sent in regular or irregular intervals. In the process illustrated in the flowchart of FIG. 2, the signal is sent after the processes at 240 or 230. The signal may identify the control unit. For example, the signal may include a unique address of the control unit. By being able to identify the control unit, the transmitter unit can ensure that a signal is sent from an associated control unit and that the transmitter unit is not receiving signals from other control units. In differing implementations, differing techniques may be used to uniquely identify the control unit associated with the transmitter unit. For example, a unique identifier, such as the address of only one of the devices, rather than each of the devices, may be used by each device to uniquely identify a conversation between the units.

At 220, a signal is transmitted to the control unit from the transmitter unit. The signal is transmitted if a signal was received at the transmitter unit from the control unit. The signal is a response that indicates the transmitter unit has received a signal from the control unit. The signal may identify the communication or unit from which the signal was transmitted. For example, the signal may identify a unique address of the transmitter unit.

At 230, the control unit determines whether the transmitter unit is beyond a limited range of communications (i.e., the range of communications between the transmitter unit and the control unit). The control unit makes this determination by measuring a strength of the signal received from the transmitter unit, and comparing the strength of that signal to a predetermined threshold. The predetermined threshold may correspond to a certain distance. The threshold that is compared against the received signal strength may be one of many thresholds selected by a user at the control unit. For example, the control unit may store three predetermined levels corresponding to a short range, medium range, and extended range, and a user may select one of the predetermined levels as a threshold to use at the control unit. In alternative implementations, other techniques may be used to determine that a transmitter unit is beyond a limited range of communications. For example, if the control unit sends a signal and a response is not received at the control unit under certain predetermined conditions (e.g., a period of time), the control unit may determine that the transmitter unit is beyond the limited range of communications.

If the transmitter unit is beyond the limited range of communications, at 240, the control unit selectively generates an alert. The alert may be a visual alert, audible alert, vibrating alert, or another suitable alert that notifies a user. The alert may be generated via the Internet. For example, an email message may be composed and sent over the Internet. As another example, the control unit may connect to a cellular service provide and cause a text message to be sent to a mobile telephone.

If the transmitter unit is not beyond the limited range of communications, or an alert has been generated, the process continues at 210 with a signal being received from a control unit at the transmitter unit (i.e., the control unit sends another signal). An alert need not be finished before the process at 210 starts again. For example, an audible alert may merely start being generated at the processes of 240 and the alert (e.g., a buzzer) may continue being generated while the processes at 210 are being performed.

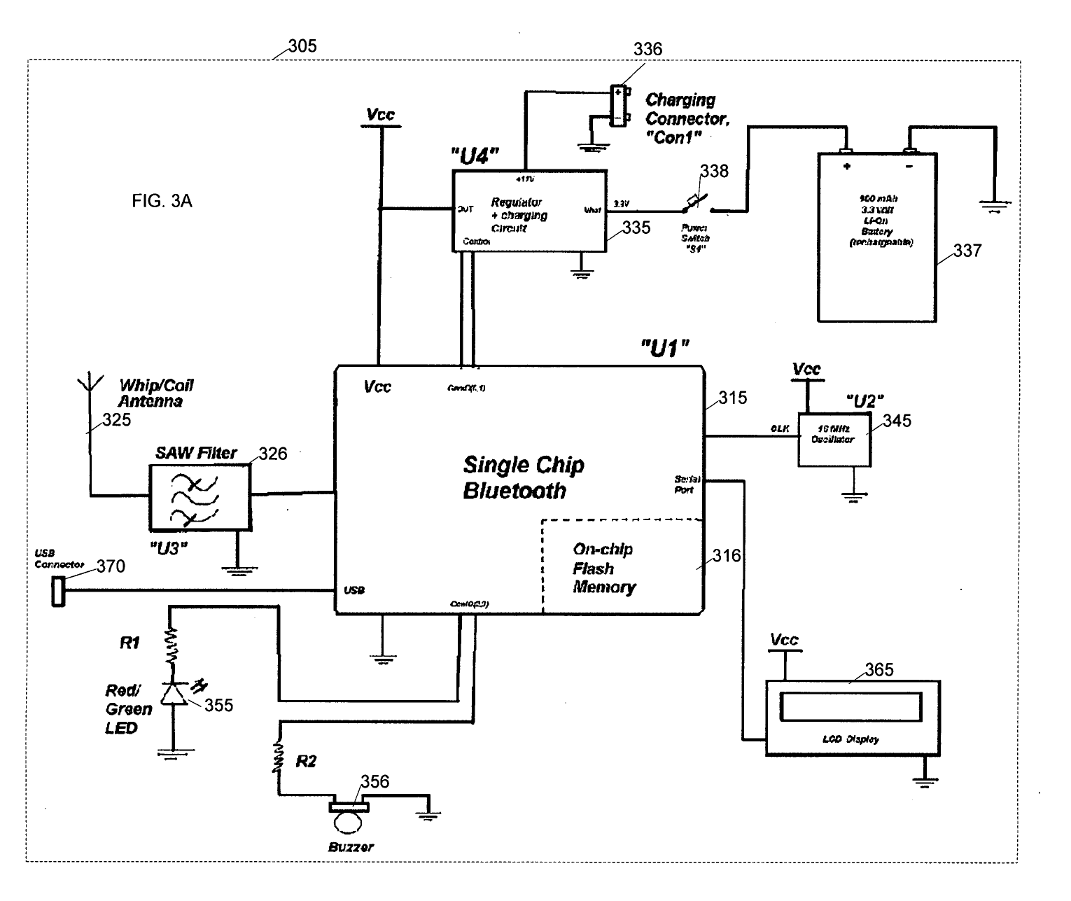

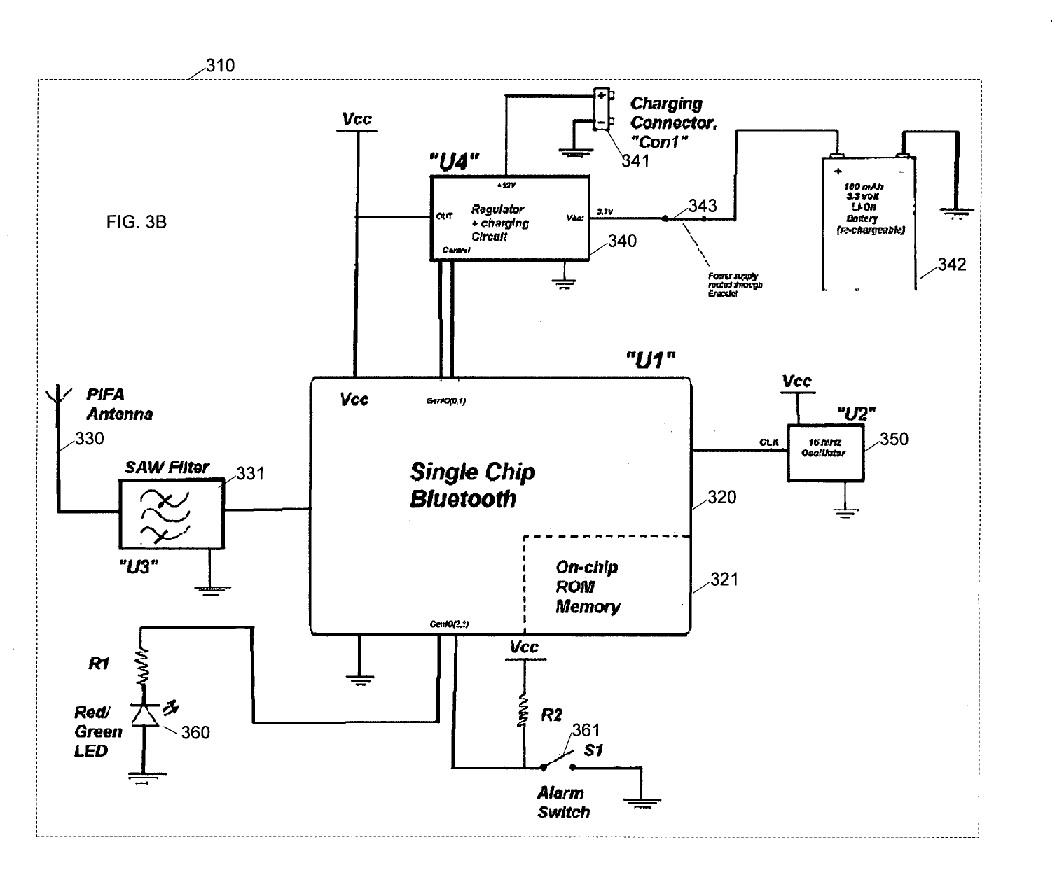

FIGS. 3A and 3B are schematic diagrams of a control unit 305 and a transmitter unit 310, respectively. The control unit 305 may be the control unit 105 and the transmitter unit 310 may be the bracelet unit 110. The units 305 and 310 include “single chip Bluetooth” chips 315 and 320; a planar inverted “F” antenna (referred to as a “PIFA”) 325 and a coil antenna 330; surface acoustic wave (referred to as “SAW”) filters 326 and 331; charging circuitry 335 and 340; charging connectors 336 and 341; power supplies 337 and 342; oscillators 345 and 350; and light emitting diodes 355 and 360.

The control unit 305 can communicate with transmitter units, such as the transmitter unit 310, via the antenna 325. Radio frequency signals received by the units 305 and 310 are filtered by the SAW filters 326 and 331, which can selectively pass, by frequency, desired signals and suppress undesired signals. The desired signals are then received at the single chips 315 and 320, respectively, which are “single chip Bluetooth” chips.

The chips 315 and 320 are single chips designed for communicating via the Bluetooth standard and include on-chip read only memory areas 316 and 321 that can be configured for controlling the Bluetooth communication. For example, the memory areas 316 and 321 may include instructions for causing the respective chips 315 and 320 to cause the control unit 305 and the transmitter 310 to interact like the control unit 105 and the bracelet unit 110, respectively. By using a single chip that includes communications logic and control logic for communications, a design of the units 305 and 310 may be simpler, more economical, and space saving. The chips 315 and 320 are driven by a clock signal generated by the oscillators 345 and 350, respectively. The chips 315 and 320 are powered by the power supplies 337 and 342, respectively, which can be recharged by using the charging connectors 336 and 341 in connection with the charging circuitry 335 and 340. The life of the power supply for the transmitter unit 310 and/or control unit 305 can be around 24 hours and may ideally be around 100 hours. Thus, a parent may have sufficient power to power the devices for over a day, or for long trips. Power is provided to the chips 315 and 320 when the switches 338 and 343, respectively, are closed. The switch 338 is closed when a power switch is switched by a user of the control unit 305. The switch 343 is closed when a user of the transmitter unit 310 closes a bracelet strap that includes an electrical connection. For example, when a user puts on the transmitter 310 for use, the transmitter unit 310 will automatically be powered, without a user having to turn on the device manually. Advantageously, because the user of the transmitter unit may be a child who would forget to manually turn off the transmitter unit 310, the transmitter unit 310 automatically stops draining power from the power supply 342 when the transmitter unit 310 is taken off.

The control unit 305 includes both the light emitting diode 355 and a buzzer 356 that can alert a user when the control unit 305 is beyond a limited range of communications with a transmitter unit, such as the transmitter unit 310. In addition, the control unit 305 may use the liquid crystal display 365 to alert a user. The light emitting diodes 355 and 360 are red/green light emitting diodes which may use the color red to indicate the units 305 and 310, respectively, are out of the range of communications and the color green to indicate that the units 305 and 310, respectively, are within the range of communications. In addition to indicating that the transmitter unit 310 is out of the range of the control unit 305, the light emitting diode 355 may be used for other suitable purposes. For example, a status of the control unit 305 (e.g., the control unit 305 is powered on) may be indicated by the light emitting diode 355.

The liquid crystal display 365 is used by the control unit 305 to display the status of the control unit 305 (e.g., the amount of power), to provide a user interface with the control unit 305 (e.g., so that a user can select a threshold level to use for determining when to send an alert), and to provide a visual alert to a user. The display 365 may further be used to identify which transmitter units, among a group of transmitter units, are beyond a limited range of communications with the control unit 305. In addition, the display 365 may provide an interface for choosing the type of alerts to use. For example, the control unit 305 may be able to use a universal serial bus connection 370 to connect to a computer system that is connected to the Internet so that an alert can be sent over the Internet. In that example, with a large variety of alerts that may be generated, a user may use the display 365 to be informed of the types of alerts that can be selected.

The universal serial bus connection 370 can connect the control unit 305 to a computer system. While connected to a computer system, the control unit 305 may generate alerts via the Internet, or the computer system may be used for input to configure options, such as a signal strength threshold. In alternative implementations, the units 305 and 310 may be adapted to include additional, differing, and/or less components. For example, the control unit 305 need not include a universal serial bus connection 370 in some implementations. As another example, the control unit 305 and the transmitter unit 310 may be adapted to include an audio channel, such that a user of the transmitter unit 310 can communicate orally with a user of the control unit 305, and/or vice versa.

In addition to alerting a user of the control unit 305 when the transmitter unit 310 is beyond a range of communications with the control unit 305, the control unit 305 may generate an alert in other circumstances. For example, the transmitter unit 310 includes an alarm switch 361 which may be closed by a user of the bracelet unit 310. Closing the switch 361 may cause the transmitter unit 310 to generate a signal indicating that the control unit 305 should generate an alert (e.g., an alert message) (i.e., a manual alert is generated rather than an automatic alert). Thus, although, for example, a child using the transmitter unit 310 may be within a communication range with a parent using the control unit 305, the child may be in danger, the child may close the switch 361 (e.g., by pressing a button located on the transmitter unit 310), and the transmitter unit 305 may be used to transmit signals that cause the control unit 305 to generate an alert. Other techniques may be used to generate an alert on the control unit 305 when the alarm switch 361 is closed. For example, closing the alarm switch 361 may cause the transmitter unit 310 to stop communicating with the control unit 305, which may be interpreted at the control unit 305 (e.g., by not receiving signals from the transmitter unit 310 in a predetermined amount of time) as indicating that the transmitter unit 310 is outside of a limited communication range (which may cause the control unit 305 to generate an alert).

Also, an alert may be generated at the control unit 305 when the transmitter unit 310 is tampered with, or removed from a user. For example, because the transmitter unit 310 may have power connected through a bracelet strap (as described above), removal of the transmitter unit 310 from a user may disturb the connection in the bracelet strap such that power is lost at the transmitter unit 310 stops communicating with the control unit 305. When the transmitter unit 310 stops communicating, the control unit 305 may generate an alert.

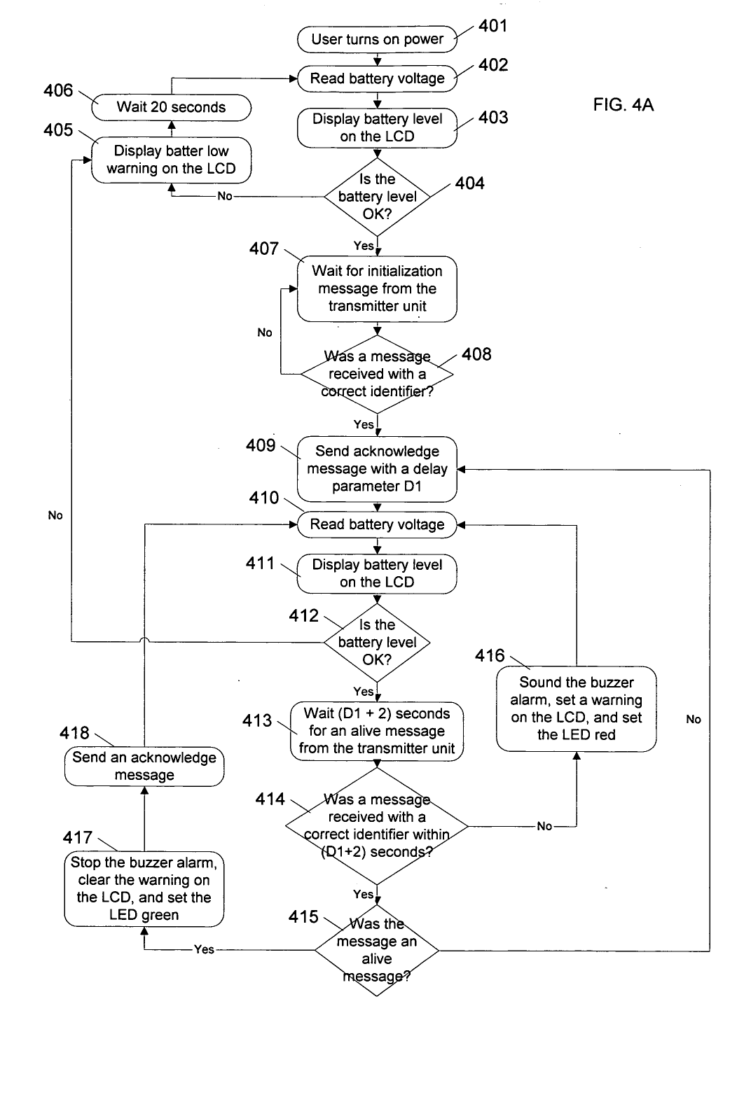

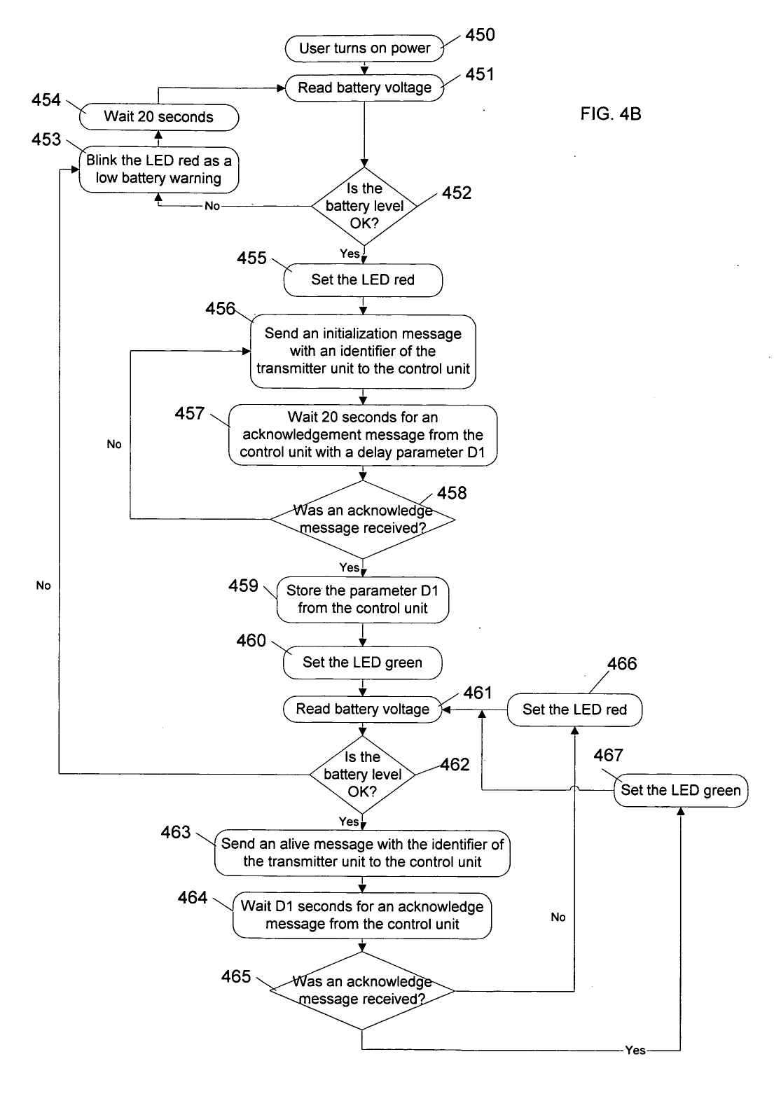

FIGS. 4A and 4B are flowcharts illustrating the processes performed by a control unit and a transmitter unit. The control unit may be similar to the control unit 305 and the transmitter unit may be similar to the transmitter unit 310. The control unit includes a light emitting diode (hereinafter “LED”) and a liquid crystal display (hereinafter “LCD”), and the transmitter unit includes an LED. According to the processes of FIGS. 4A and 4B, the transmitter unit periodically sends messages and the control unit waits a predetermined amount of time for an alive message before generating a visual alert to a user. In alternative implementations, other techniques may be implemented; and the units may include additional, different and/or fewer components.

The processes start at 401 and 450 when a user turns on the power for each device. The control unit may be turned on when a user moves a switch to an “on” position, while the transmitter unit may be turned on when a user closes a bracelet that is electrically connected to power circuitry.

The battery voltage for each unit is checked at 402 and 451, and if the battery level is determined to be low at 404 and 452, a warning is indicated to a user at 405 and 453, a delay is caused at 406 and 454, and the process continues warning a user until the battery voltage is sufficient. In other words, each unit continues to generate a warning until a power supply is recharged or switched. In addition to warning a user, the LCD of the control unit displays the battery level at 403.

If the battery level is sufficient, the processes can continue at 407 and 455 for the control unit and the transmitter unit, respectively. At 456 and 457, an initialization message is sent with an identifier of the transmitter unit from the transmitter unit to the control unit until an acknowledge message is received from the control unit at 458. If an acknowledge message is not received, the transmitter unit continues to send the initialization message and wait (457 and 458).

At 407 and 408, the control unit waits for the initialization message from the transmitter unit, and determines if any initialization message was received from the correct transmitter unit (i.e., a transmitter unit that has an identifier corresponding to a transmitter unit associated with the control unit). If an initialization message is received from the correct transmitter unit, the control unit sends and acknowledge message with a parameter indicating a delay D1 that the transmitter unit should wait between acknowledge messages from the control unit, at 409.

If the acknowledge message is received at the transmitter unit at 458, the delay D1 is stored at the transmitter unit at 459 and the transmitter unit sets the LED to green at 460 to indicate that the transmitter unit is working and within a range of communications with the control unit.

At 410 to 412 and 461 to 462, the battery voltages for the units are checked and if the battery voltage is sufficient, the processes continue; otherwise, warnings are generated at 405 and 453 for the control unit and the transmitter unit, respectively. If the battery voltage is sufficient, a message is transmitted by the transmitter unit at 463 that includes the identifier of the transmitter unit and the transmitter unit waits at 464 for D1 seconds. At 413, after waiting D1+2 seconds, the transmitter unit determines if a message was received from the transmitter unit at 414. If a message was not received from the proper transmitter unit, at 416 several alerts are generated (i.e., a buzzer alarm, a warning on the LCD, and the LED is set to red). The control unit continues to generate an alert while performing the processes of 410 through 414 until a message is received from the proper transmitter unit, and the message was of the “alive” type (415) (i.e., not an init message). The buzzer and LED are only stopped at 417, after an alive message was received from the proper transmitter unit. If an alive message was not received, which may indicate that the acknowledge message was not received from the transmitter unit at 458, the control unit sends an acknowledge message at 409.

After an alive message is received, the control unit generates an acknowledge message at 418. The transmitter unit waits for the acknowledge message at 464, and unless the acknowledge message is received (465), the transmitter unit visually alerts a user that the transmitter unit is beyond the range of communications with the control unit by setting the LED red at 466. Otherwise, if an acknowledge message was received, at 467 the LED is set to green to indicate the transmitter unit is working and the transmitter unit is within the range of communications.

The control unit continues the processes of checking the battery life, waiting for alive messages from the transmitter unit, and sending acknowledge messages until the battery is low or the unit is turned off (not included in the flowchart). Likewise, the transmitter unit continues to send alive messages and wait for acknowledge messages until the battery voltage is low (at 462) or the unit is turned off (not included in the flowchart).

The disclosed subject matter and all of the functional operations described herein can be implemented in digital electronic circuitry, or in computer software, firmware, or hardware, including the structural means disclosed in this specification and structural equivalents thereof, or in combinations of them. The disclosed subject matter can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described herein, including the method steps of the disclosed subject matter, can be performed by one or more programmable processors executing one or more computer programs to perform functions of the disclosed subject matter by operating on input data and generating output. The processes and logic flows can also be performed by, and apparatus of the disclosed subject matter can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the disclosed subject matter can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed subject matter can be implemented in a computing system that includes a back-end component (e.g., a data server), a middleware component (e.g., an application server), or a front-end component (e.g., a client computer having a graphical user interface or a Web browser through which a user can interact with an implementation of the disclosed subject matter), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Although the methods of FIGS. 2, 4A, and 4B are shown as being composed of certain processes, additional and/or different processes can be used instead. Similarly, the processes need not be performed in the order depicted. Thus, although a few implementations have been described in detail above, other modifications are possible. Other implementations may be within the scope of the following claims.

1. A system comprising:
a transmitter unit operable to transmit radio frequency signals within a limited range of communications; and
a control unit operable to receive radio frequency signals from the transmitter unit and to generate an alert if the control unit determines that the transmitter unit is beyond the limited range of communications.

2. The system of claim 1, wherein the control unit is configured to determine that the transmitter unit is beyond the limited range of communications upon detecting an occurrence of a predetermined condition.

3. The system of claim 2, wherein detecting an occurrence of the predetermined condition comprises detecting that the transmitter unit failed to transmit a radio frequency signal within a predetermined period of time.

4. The system of claim 2, wherein the control unit is adapted to transmit radio frequency signals to the transmitter unit at regular intervals, the transmitter unit is adapted to send response signals to the control unit, and wherein detecting an occurrence of the predetermined condition comprises detecting that the transmitter unit failed to respond to a transmission from the control unit.

5. The system of claim 2, wherein the control unit is adapted to measure a strength of a signal from the transmitter unit, and detecting an occurrence of the predetermined condition comprises detecting that the control unit received a signal from the transmitter unit below a predetermined signal strength level.

6. The system of claim 5, wherein the control unit is adapted to store a plurality of predetermined signal strength levels, and the control unit is configured to allow a user to select one of the predetermined signal strength levels and to generate the alert based on the signal strength selected by the user.

7. The system of claim 1, wherein the control unit is configured to determine that the transmitter unit is beyond the limited range of communications when at least the radio frequency signals from the transmitter unit are obstructed, the radio frequency signals fail to be received at the control unit when the transmitter unit has low power or is not powered, or the control unit or the transmitter unit malfunctions.

8. The system of claim 1, wherein the transmitter unit is adapted to be secured to a person.

9. The system of claim 1, wherein the transmitter unit comprises a bracelet.

10. The system of claim 1, wherein the control unit is adapted to transmit radio frequency signals to the transmitter unit at regular intervals, and the transmitter unit is adapted to send response signals to the control unit.

11. The system of claim 10, wherein the control unit increases a frequency of transmitting signals if the transmitter unit is out of the limited range of communications with the control unit.

12. The system of claim 1, wherein the control unit communicates with the transmitter unit using a Bluetooth radio frequency link.

13. The system of claim 1, wherein the alert is an audible alarm.

14. The system of claim 1, wherein the alert is a visual alarm.

15. The system of claim 1, wherein the alert is a vibration alarm.

16. The system of claim 1, wherein the transmitter unit is adapted to generate an alert if the transmitter unit determines that the control unit is beyond the limited range of communications.

17. The system of claim 1, wherein the control unit is mobile.

18. The system of claim 1, wherein the control unit is a bracelet adapted to be secured around part of a person.

19. The system of claim 1, wherein the control unit is adapted to send alert signals to a device via the Internet, and generating the alert comprises sending alert signals to the device via the Internet.

20. The system of claim 1, wherein the control unit is adapted to send wireless alert signals to a device, and generating the alert comprises wirelessly sending alert signals to the device.

21. The system of claim 1, wherein the control unit recognizes a unique communication address of the transmitter unit.

22. The system of claim 1, wherein the control unit is adapted to communicate with a plurality of transmitter units using continuous streams of radio frequency signals with limited ranges of wireless communications, the control unit being configured to identify the transmitter unit among a plurality of transmitter units that are beyond one of the limited ranges of wireless communications, and the control unit being configured to generate the alert if at least one of the transmitter units is beyond one of the limited ranges of wireless communications.

23. A method of alerting a user that a transmitter unit is beyond a limited range of communicating wirelessly with a control unit, the method comprising:
wirelessly transmitting a radio frequency signal from the transmitter unit to the control unit;
determining at the control unit whether the transmitter unit is beyond the limited range of wireless communications; and
selectively generating an alert at the control unit based on a result of the determination.

24. The method of claim 23, wherein determining at the control unit whether the transmitter unit is beyond the limited range of wireless communications comprises detecting an occurrence of a predetermined condition.

25. The method of claim 24, wherein detecting an occurrence of the predetermined condition comprises detecting that the transmitter unit failed to transmit the radio frequency signal within a predetermined period of time.

26. The method of claim 24, wherein detecting an occurrence of the predetermined condition comprises detecting that the transmitter unit failed to respond to a transmission from the control unit.

27. The method of claim 24, wherein detecting an occurrence of the predetermined condition comprises detecting that the radio frequency signal from the transmitter unit is below a predetermined signal strength level.

28. The method of claim 23, wherein the transmitter unit is beyond the limited range of wireless communications when at least the radio frequency signal from the transmitter unit is obstructed, the radio frequency signal fails to be received at the control unit when the transmitter unit has low power or is not powered, or the control unit or the transmitter unit malfunctions.

29. The method of claim 23, wherein the transmitter unit is a bracelet.

30. The method of claim 23, wherein the control unit is a bracelet.

31. The method of claim 23, wherein determining whether the transmitter unit is beyond the limited range of wireless communications comprises:
measuring a strength of the signal transmitted by the transmitter unit; and
determining that the control unit is beyond the limited range of wireless communications if the measured strength is below a predetermined level.

32. The method of claim 23, wherein determining whether the transmitter unit is beyond the limited range of wireless communications comprises determining whether a strength of the radio frequency signal is below the selected predetermined level, the method further comprising:
receiving input selecting one of a plurality of predetermined signal strength levels at the control unit.

33. The method of claim 23, further comprising:
the control unit selectively transmitting alert signals to a device if the transmitter unit is beyond the limited range of wireless communications.

34. The method of claim 23, wherein the control unit is adapted to communicate with a plurality of transmitter units using continuous streams of radio frequency signals with limited ranges of wireless communications, the control unit is configured to generate the alert if at least one transmitter units is beyond one of the limited ranges of wireless communications, and determining that the control unit is beyond the limited range of wireless communications comprises:
the control unit identifying the transmitter unit among a plurality of transmitter units that are beyond the limited range of communications.

35. A control unit comprising:
a receiver to receive radio frequency signals from one or more transmitter units;
circuitry to determine whether one or more of the transmitter units are within a limited wireless communications range; and
circuitry to selectively alert a user of the control unit upon determining that one or more of the transmitter units are outside of the limited wireless communication range.

36. The control unit of claim 35, wherein the control unit is a bracelet.

37. The control unit of claim 35, wherein the circuitry to determine whether one or more of the transmitter units are within a limited wireless communications range is configured to determine that the transmitter units are within the limited wireless communications range upon detecting an occurrence of a predetermined condition.

38. The control unit of claim 37, wherein detecting an occurrence of the predetermined condition comprises detecting that the transmitter unit failed to transmit a radio frequency signal within a predetermined period of time.

39. The control unit of claim 37, wherein detecting an occurrence of the predetermined condition comprises detecting that a measured strength of radio frequency signals is below a predetermined signal strength level, the control unit further comprising circuitry to measure the strength of the received radio frequency signals.

40. The control unit of claim 39, wherein the control unit is beyond the limited range of wireless communications if the measured strength is below a selected predetermined level, the control unit further comprising:
circuitry to store a plurality of predetermined signal strength levels, and
circuitry to allow a user to select one of the predetermined signal strength levels.

41. The control unit of claim 35, wherein the circuitry to determine whether one or more of the transmitter units are within a limited wireless communications range is configured to determine that the transmitter units are within a limited wireless communications range when at least the radio frequency signals from the transmitter units are obstructed, the radio frequency signals fail to be received at the control unit when the transmitter units have low power or are not powered, or the control unit or the transmitter units malfunction.

42. The control unit of claim 35, wherein the circuitry to determine whether one or more of the transmitter units are within a limited wireless communications range is configured to determine that the transmitter units are within a limited wireless communications range if the control unit fails to receive a response to a radio frequency signal sent from the control unit, the control unit further comprising:
circuitry configured to send a continuous stream of radio frequency signals with the limited range of communications to the transmitter unit.
